(19) United States
(12) Patent Application Publication
(10) Pub. No.: US 2019/0238943 A1
(43) Pub. Date: Aug. 1, 2019

(54) Method, Server, and Client for Updating Playback Record

(71) Applicant: Alibaba Group Holding Limited, Grand Cayman (KY)

(72) Inventor: Yang Song, Shanghai (CN)

(73) Assignee: Alibaba Group Holding Limited

(21) Appl. No.: 16/259,986

(22) Filed: Jan. 28, 2019

(30) Foreign Application Priority Data
Jan. 29, 2018 (CN) 201810081653.5

(51) Int. Cl. H04N 21/458; H04N 21/258; H04N 21/472; H04N 21/262

(52) U.S. Cl. CPC H04N 21/4586; H04N 21/26291; H04N 21/47217; H04N 21/25808

(57) ABSTRACT

A method, a server, and a client for updating a playing record are provided. The method includes receiving a progress backup request sent by a current terminal device, wherein the progress backup request includes a playing progress of a target video on the current terminal device and an identifier that represents the current terminal device, and the current terminal device is logged in with a specified user account; determining a playing sub-record of the current terminal device from a video playing record of the specified user account based on the identifier; and storing a playing progress of the target video on the current terminal device in the playing sub-record of the current terminal device to update the video playing record of the specified user account. The technical solutions provided by the present application can distinguish between playing records of different users.

### CROSS REFERENCE TO RELATED PATENT APPLICATIONS

This application claims priority to Chinese Patent Application No. 201810081653.5, filed on 29 Jan. 2018, entitled “Method, Server, and Client for Updating Playback Record,” which is hereby incorporated by reference in its entirety.

### TECHNICAL FIELD

The present application relates to the technological field of the Internet, and particularly to methods, servers, and clients for updating a playback record.

### BACKGROUND

In an existing video playing website, the video playing website usually records a playing progress of a video when a user watches the video. Specifically, the user may register an account in the video playing website. As such, when the registered account is in a login status, the video playing website can record the playing progress of a video into that account. Therefore, the user can continue to play the corresponding video according to the recorded playing progress of the video.

In practical application scenarios, it is very likely that multiple persons will use the same account to log in to a video playing website. For example, two users use the same account in a video playing website, and these two users are watching the same episode. Then, according to an existing method of recording the playing progress, when these two users use the same account to view the episode, the playing progress related to the episode that is recorded under this account is continuously updated as the episode is played, resulting in playing progress of these two users being mutually overwritten. Thus, these two users cannot know their actual viewing progress according to the playback progress recorded in the account. Therefore, a more accurate method for updating the playback progress is needed.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “techniques,” for instance, may refer to device(s), system(s), method(s) and/or processor-readable/computer-readable instructions as permitted by the context above and throughout the present disclosure.

An objective of embodiments of the present application is to provide a method, a server, and a client for updating a playing record, which can distinguish playing records of different users.

In implementations, the present application provides a method for updating a playing record. The method includes receiving a progress backup request sent by a current terminal device, wherein the progress backup request includes a playing progress of a target video on the current terminal device and an identifier that represents the current terminal device, and the current terminal device is logged in with a specified user account; determining a playing sub-record of the current terminal device from a video playing record of the specified user account based on the identifier; and storing a playing progress of the target video on the current terminal device in the playing sub-record of the current terminal device to update the video playing record of the specified user account.

In implementations, the present application further provides a server. The server includes processor(s) and memory. The memory stores a computer program. When the computer program is executed by the processor(s), the following steps are implemented: receiving a progress backup request sent by a current terminal device, wherein the progress backup request includes a playing progress of a target video on the current terminal device and an identifier that represents the current terminal device, and the current terminal device is logged in with a specified user account; determining a playing sub-record of the current terminal device from a video playing record of the specified user account based on the identifier; and storing a playing progress of the target video on the current terminal device in the playing sub-record of the current terminal device to update the video playing record of the specified user account.

In implementations, the present application further provides a method for updating a playing record. The method includes playing a specified video by a current terminal device, and recording a playing progress of the specified video on the current terminal device, wherein the current terminal device is logged in with a specified user account; obtaining an identifier that represents the current terminal device; sending the playing progress of the specified video on the current terminal device and the obtained identifier to a server, to enable the server to determine a playing sub-record of the current terminal device from a video playing record of the specified user account based on the identifier, and store the playing progress of the specified video on the current terminal device in the playing sub-record of the current terminal device.

In implementations, the present application further provides a client, where the client includes processor(s), memory, and a display. The memory stores a computer program. When the computer program is executed by the processor(s), the following steps are implemented: playing a specified video through the display, and recording a playback progress of the specified video in the client, wherein the client is logged in with a specified user account; and obtaining an identifier that represents the client; sending the playing progress of the specified video in the client and the obtained identifier to the server, to enable the server to determine a playing sub-record of the client from a video playing record of the specified user account based on the identifier, and store the playing progress of the specified video in the client in the playing sub-record of the client.

As can be seen from the above, in the technical solutions provided by the present application, when a user logs in with a specified user account in a current terminal device and uses the current terminal device to watch a video, the current terminal device can send the playing progress of the video and an identifier thereof to a server. In this way, when updating a video playing record of the user, the server can determine which terminal device the playing progress is generated from by using the received identifier. The video playing record of the specified user account may be saved in the server, and the video playing record may be divided into multiple playing sub-records according to different terminal devices. When updating the playing progress of the video, the server may save the playing progress of the video into a playing sub-record of the current terminal device, indicating that the playing progress of the video is generated in the current terminal device. For playing sub-records of other terminal devices, no changes may be made. Thus, when terminal devices that are logged in with the specified user account need to load a video playing record, the server can provide a video playing record including various playing sub-records. When the terminal devices display the video playing record, the video playing record can be classified and displayed according to the terminal devices. In this way, even if two users watch the same episode using the same account, as long as these two users use their individual terminal devices, their viewing records will not be overwritten by each other, and will be recorded separately in playing sub-records of their individual terminal devices. By distinguishing between terminal devices in a video playing record, a user can accurately know the progress of watching a video thereof without being confused with viewing progresses of others. As can be seen, the technical solutions provided by the present application can distinguish between playing records of different users.

### BRIEF DESCRIPTION OF THE DRAWINGS

In order to illustrate the technical solutions of the embodiments of the present application more clearly, accompanying drawings needed by the embodiments are briefly described herein. Apparently, the drawings in the following description represent some embodiments described in the present application. Based on these drawings, other drawings can be obtained by one skilled in the art without making any inventive effort.

FIG. 1 is a flowchart of a method for updating a playing record in implementations of the present application.

FIG. 2 is a schematic diagram of storing a video playing record in implementations of the present application.

FIG. 3 is a schematic diagram of a historical recording interface in implementations of the present application.

FIG. 4 is a schematic diagram of a combined historical record interface in implementations of the present application.

FIG. 5 is a schematic diagram of a combined playing record in implementations of the present application.

FIG. 6 is a schematic structural diagram of a server in implementations of the present application.

FIG. 7 is a flowchart of a method for updating a playing record in implementations of the present application.

FIG. 8 is a schematic diagram of showing playback progresses according to time periods in implementations of the present application.

FIG. 9 is a schematic structural diagram of a client in implementations of the present application.

### DETAILED DESCRIPTION

In order to enable one of skill in the art to better understand the technical solutions in the present application, the technical solutions in the embodiments of the present application will be clearly and completely described hereinafter with reference to the accompanying drawings in the embodiments of the present application. The embodiments merely represent a part and not all of the embodiments of the present application. All other embodiments that are obtained by one of ordinary skill in the art based on the embodiments of the present application without making any inventive effort shall fall within the scope of protection of the present application.

The present embodiment provides a method for updating a playing record, and the method can be applied in a server. The server may be a service server for a video playing website. The server can store video resource, and can also store registration information of users in the video playing website. In practical applications, storing video resources and the registration information may be implemented by two independent servers, or may be implemented by a same server, which is not limited in the present application.

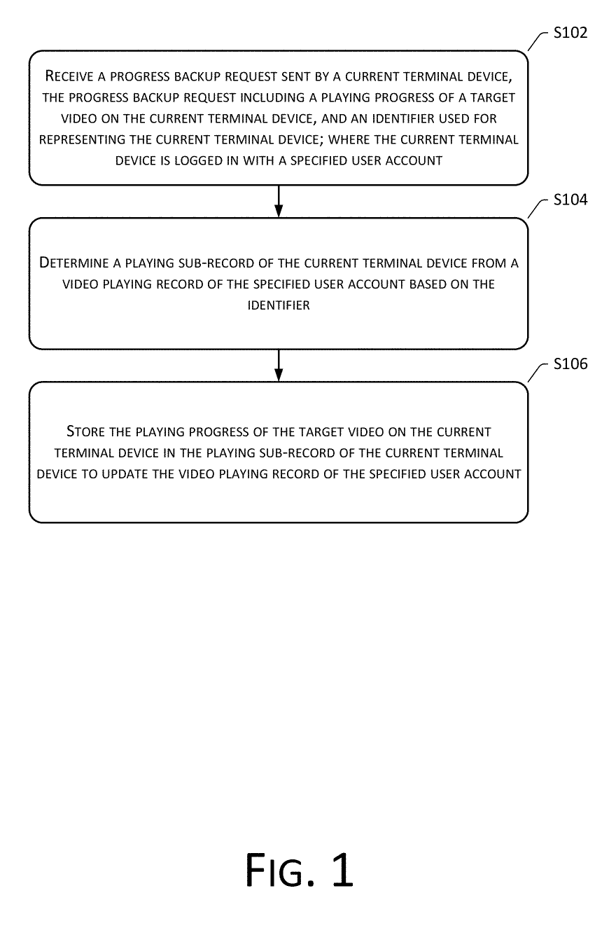

Referring to FIG. 1, a method 100 for updating a playing record includes the following operations.

5102: Receive a progress backup request sent by a current terminal device, the progress backup request including a playing progress of a target video on the current terminal device, and an identifier used for representing the current terminal device; where the current terminal device is logged in with a specified user account.

In implementations, a user can access the video playing website through the current terminal device. The current terminal device may be an electronic device such as a smart phone, a tablet computer, a notebook computer, a desktop computer, a smart television, a smart wearable device (a smart watch, a virtual reality helmet, etc.). The user can access the video playing website through software installed in the current terminal device. The software may be, for example, a browser or an APP (Application) of the video playing website.

In implementations, when the user accesses the video playing website through the current terminal device, the specified user account that has been registered in the video playing website may be logged in the current terminal device. Information of the user may be stored in association with the specified user account in a server of the video playing website. The information of the user may include information inputted by the user at the time of registration, such as nickname, gender, date of birth, hobbies, etc. and may also include behavior data of the user when browsing the video playing website, for example, themes that the user likes to watch, online time durations of the user, a video playing record of the user, and so on.

In implementations, when the specified user account remains in a login state, if the user is watching a certain video, the current terminal device can send the playing progress of the video that the user is watching to the server, thereby backing up the video playing record of the user through the server. Specifically, when the current terminal device plays the target video, a playback page of the target video or the APP of the video play website records a current playing progress of the target video according to a specified period. The specified period may be pre-specified by a developer of the video playing website. For example, the specified period may be 2 seconds. In this way, the current playing progress of the target video can be recorded every 2 seconds. The current playing progress may be a current playing time duration of the target video. For example, when the current playing progress is recorded, the target video is played to 4 minutes and 15 seconds. Then, 4 minutes and 15 seconds can be used as the current playing progress. In addition, the current playing progress may also be a proportion of the current playing time duration of the target video in the total time duration. For example, when the current playing progress is recorded, the target video is played for 4 minutes and 15 seconds, and the total time duration of the target video is 10 minutes. Then, a ratio between 4 minutes 15 seconds and 10 minutes, 42.5%, can be used as the current playing progress. Apparently, in practical applications, the APP of the video playing website can also record the current playing progress of the target video when the APP is closed or exited from a current interface. Specifically, in response to receiving an instruction of closing or exiting, the APP may record the current playing progress of the target video that is played in the APP, and then may send the current playing progress that is recorded and an identifier of the target video to the server, so that the server can back up the current playing progress of the target video.

In implementations, while the playing progress of the target video in the current terminal device is recorded, an identifier used for representing the current terminal device may be obtained in order to clearly indicating that the playing progress is recorded in the current terminal device. Specifically, the identifier may be used to uniquely represent the current terminal device, so that the current terminal device can be distinguished from other terminal devices. In practical applications, the identifier may be a unique character string such as an International Mobile Equipment Identity (IMEI) or a MAC address of the current terminal device. In addition, the identifier may be a character string obtained after performing a hash mapping on the above IMEI or MAC address. For example, the identifier may be an MD5 code generated from the IMEI. In implementations, the identifier may be stored in a specified directory of the current terminal device when the current terminal device is produced or activated. In this way, by reading data in the specified directory, the identifier used for representing the current terminal device can be obtained.

In implementations, after the playing progress of the target video is recorded and the identifier of the current terminal device is obtained, the current terminal device may initiate a progress backup request to the server. The request may include the recorded playback progress and the obtained identifier. Apparently, in practical applications, the progress backup request may further include an identifier that is used for representing the specified user account. The identifier that represents the specified user account may be the specified user account itself, or may be a background digital series number corresponding to the specified user account. The present application does not have any limitations on implementations thereof, as long as the uniqueness can be guaranteed.

S104: Determine a playing sub-record of the current terminal device from a video playing record of the specified user account based on the identifier.

In implementations, the user account may be stored in association with a corresponding video playing record in the server. The video playing record may have multiple playing sub-records, and these playing sub-records can be separately bound to different terminal devices. Specifically, playing progresses generated in a same terminal device can be stored in a playing sub-record of that terminal device. In this way, even if user accounts that are logged in are the same, playing progresses generated in different terminal devices do not interfere with each other. For example, user A and user B share a same user account, in which the user A uses an Apple mobile phone to watch video, and the user B uses a Huawei mobile phone to watch video. At this time, a playing progress generated by the user A watching the video is classified into a playing sub-record of the Apple mobile phone, and a playing progress generated by the user B watching the video is classified into a playing sub-record of the Huawei mobile phone. Even if these two users are watching the same episode, they will not be mutually overwritten because their playing progresses are in different playing sub-records.

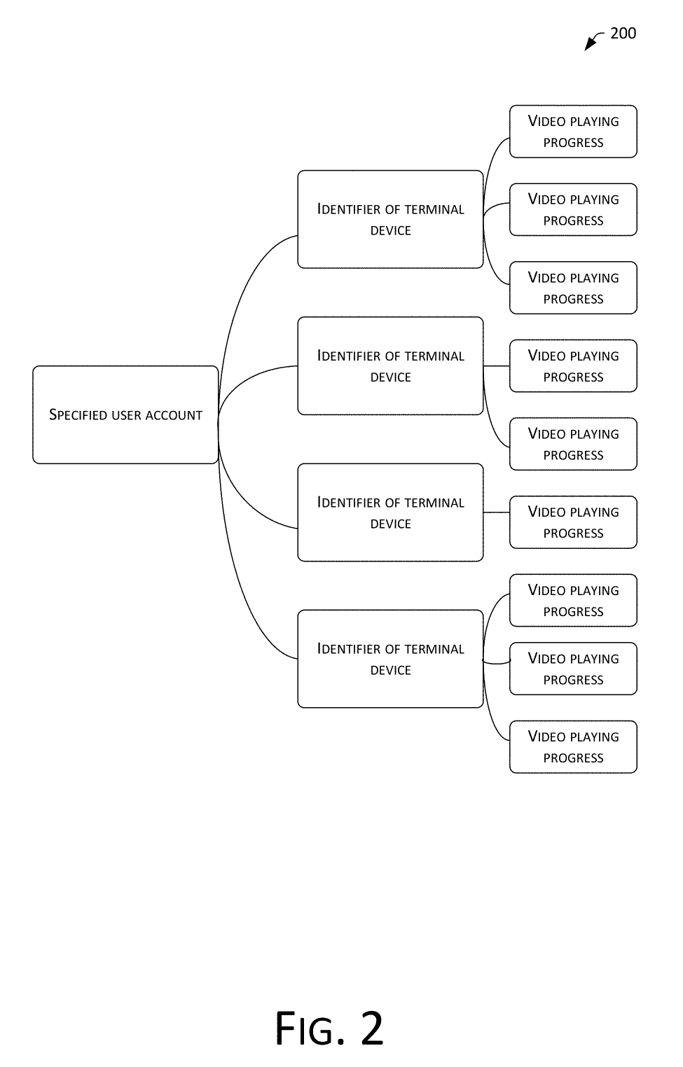

In implementations, after receiving the progress backup request sent by the current terminal device, the server may identify from which user account the progress backup request is sent, from which the playing progress of the target video and the identifier of the current terminal device can be extracted. In this way, the server can locate a video playing record of the specified user account according to the identified user account, and then can determine a playing sub-record of the current terminal device in the video playing record according to the identifier of the current terminal device. Referring to FIG. 2, in practical applications, a tree structure 200 may be used to construct the video playing record as described above. The specified user account can be used as a parent node, and each child node connected to the parent node can separately correspond to a playing sub-record of a different terminal device. The parent node may use the specified user account as index information, and a child node may use an identifier of a terminal device as index information. In this way, according to corresponding index information, a playing sub-record pointed to by the identifier of the current terminal device under the specified user account may be located layer by layer from among a plurality of video playing records.

S106: Store the playing progress of the target video on the current terminal device in the playing sub-record of the current terminal device to update the video playing record of the specified user account.

In implementations, after the playing sub-record of the current terminal device is determined, the playing progress generated by the target video on the current terminal device may be stored into the playing sub-record. Specifically, when the playing progress is stored, a determination may be made as to whether a playing progress of the target video exists in the playing sub-record of the current terminal device. The video and a corresponding playing progress may also be stored in association in the playing sub-record, wherein each video may be represented by a digital series number of the video playing website. In this way, by querying whether a digital series number of the target video exists in the playing sub-record, a determination can be made as to whether a playing progress of the target video exists in the playing sub-record. If affirmative, this indicates that a playing progress has been generated by the target video in the current terminal device. At this time, the previous playing progress can be overwritten by the current playing progress. Specifically, the playing progress of the target video in the progress backup request may be used to overwrite the playing progress of the target video that already exists in the playing sub-record. If a playing progress of the target video does not exist in the playing sub-record, this indicates that the playing progress of the target video is generated in the current terminal device for the first time. As such, the playing progress of the target video in the progress backup request may be directly written into the playing sub-record. Through the above processing, a playing sub-record of each terminal device under the specified user account can be updated continuously.

In implementations, a playing sub-record of the current terminal device may not exist in the video playing record of the specified user account. In this case, a playing sub-record of the current terminal device may be created in the video playing record of the specified user account. The created playing sub-record may be bound to the identifier of the current terminal device. In this way, when a playing progress of the target video generated on the current terminal device is subsequently received, the playing progress of the target video on the current terminal device can be written into the created playing sub-record.

In implementations, the video playing website may have a historical record page of a user. The historical record page can display a video playing record of the user. Specifically, the user can log into the specified user account on a terminal device. As such, if a current page of the terminal device jumps to a historical record page, the terminal device can automatically send a request for loading a playing record that is directed to the specified user account to the server. The request for loading a playing record may include an identifier that represents the specified user account. The identifier may be the specified user account itself, or may be a corresponding digital series number of the specified user account in the video playing website. In this way, after receiving the request for loading a playing record, the server may return the video playing record of the specified user account to a requester that sends the request for loading the playing record.

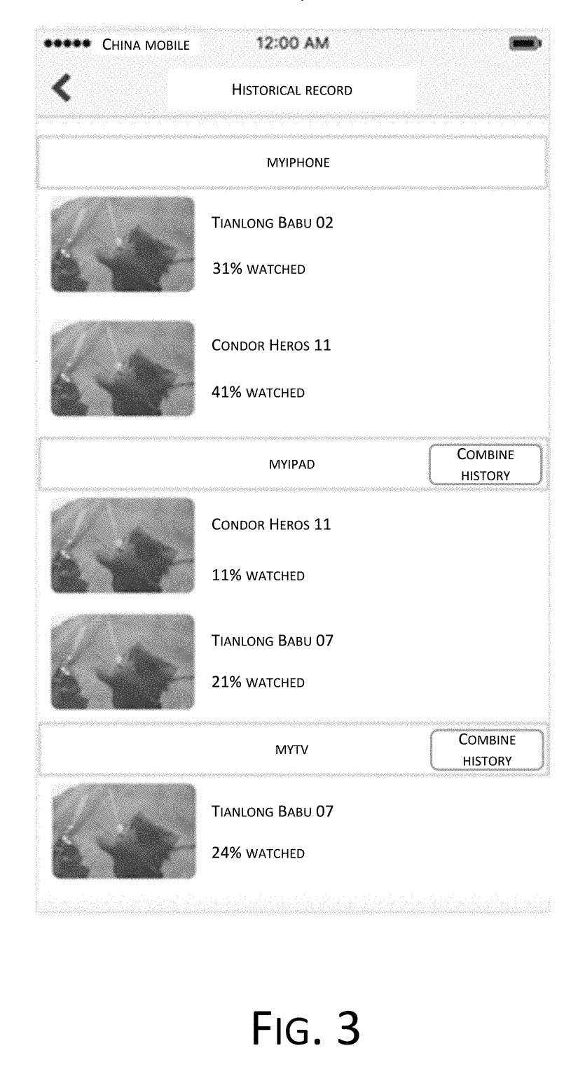

In implementations, after receiving the video playing record returned by the server, the terminal device may display the video playing record in the current historical record page. Referring to FIG. 3, the video playing record may include playing sub-records of a plurality of terminal devices, and names of the terminal devices and playing progresses of various videos respectively generated in the terminal devices may be displayed. If the specified user account has playing sub-records of a plurality of terminal devices, the playing sub-records of the plurality of terminal devices may be independently displayed in the video playing record. A playing progress of a video in the video playing record may be associated with a terminal device that generates the playing progress. Therefore, playing progresses of videos in the video playing record can be categorized and displayed in the video playing record according to terminal devices that generate the playing progresses as shown in FIG. 3. Playing progresses displayed in a same category is associated with a same terminal device. In implementations, since an identifier of a terminal device described above is unique, a representation thereof is usually complicated and difficult to be remembered by the user. Therefore, in order to facilitate identification by the user, a name that is easily recognized by the user can be employed when being presented to the user. Specifically, the name that is easily recognized by the user may be a model number of the terminal device. For example, if the current terminal device is an Apple mobile phone, the name displayed to the user may be “myiphone”. If there are multiple terminal devices of a same model, corresponding suffixes can be added on top of a character string representing the model number to distinguish between different terminal devices. For example, if a user uses two Huawei mobile phones to watch videos, display names of these two Huawei mobile phones can be “muhuawei 1” and “myhuawei 2” respectively, in which 1 and 2 can be added suffixes as described above.

In implementations, the name presented to the user may be set by the user himself/herself. For example, after the user accesses the video playing website using a certain terminal device and logs in the specified user account, a text input box with a prompt message “Please set a name for the device you are currently using” may pop up in a page of the video playing website. After the user enters a corresponding name in the text input box, the server of the video playing website can bind the input name with the identifier of the terminal device. When the name of the terminal device needs to be displayed in a display page of the user, the name previously entered by the user can be displayed. In addition, the name displayed to the user may also be automatically generated by the server of the video playing website according to a model identification result of the terminal device. For example, a naming rule for terminal devices can be pre-configured in the server, and the naming rule is “model+suffix”, in which a model can be a text corresponding to an identified model. For example, a text corresponding to an iPhone is “myiphone”, and a text corresponding to a Huawei phone is “myhuawei”. The suffix may be added when duplicate texts corresponding to a model occur, so that a name after a suffix is added is unique for the same specified user account. The suffix can be a number that is not repeated. For example, a name with an added suffix can be “myhuawei 1”.

In implementations, in order to distinguish the terminal device currently used by the user from other terminal devices, the playing sub-record of the current terminal device may be displayed before the playing sub-records of the other terminal device. For example, in FIG. 3, the user currently uses a mobile phone. A playing sub-record of the mobile phone can then be displayed in the first place, and a term “current device” can be indicated after a name of the mobile phone is indicated.

In implementations, a playing progress of each video displayed in the video playing record can continue to be played on the current terminal device. For example, in FIG. 3, the current terminal device is myiphone, but 21% of a video of “Tianlong Babu 07” that has been watched in a playing sub-record corresponding to myipad, and the video can continue to be played in the current terminal device. Specifically, when a playing progress of a target video in a video playing record is triggered, the target video may continue to be played in a current terminal device according to the playing progress of the target video. For example, after the 21% of the above-mentioned video of “Tianlong Babu 07” is triggered, the current terminal device can start playing the content of “Tianlong Babu 07” from the playing progress of 21%. When the target video is played, the playing progress of the target video on the current terminal device may be recorded according to the description at step S102, and the playing progress of the target video on the current terminal device and the identifier of the current terminal device are sent to the server, so that the server stores the playing progress of the target video on the current terminal device in the playing sub-record of the current terminal device. For example, in FIG. 3, for such drama series of “Tianlong Babu”, the playing progress in the current device is 31% of the second episode. If the user clicks on the seventh episode that has been watched up to 21% in myipad, the current device will then start playing from 21% of the seventh episode. Furthermore, during playback, an original progress of 31% of the second episode in the current device is overwritten. As such, the playing progress of the drama series of “Tianlong Babu” in the current device is gradually updated from 21% of the seventh episode. Apparently, the playing progress of the drama series of “Tianlong Babu” in myipad remains unchanged.

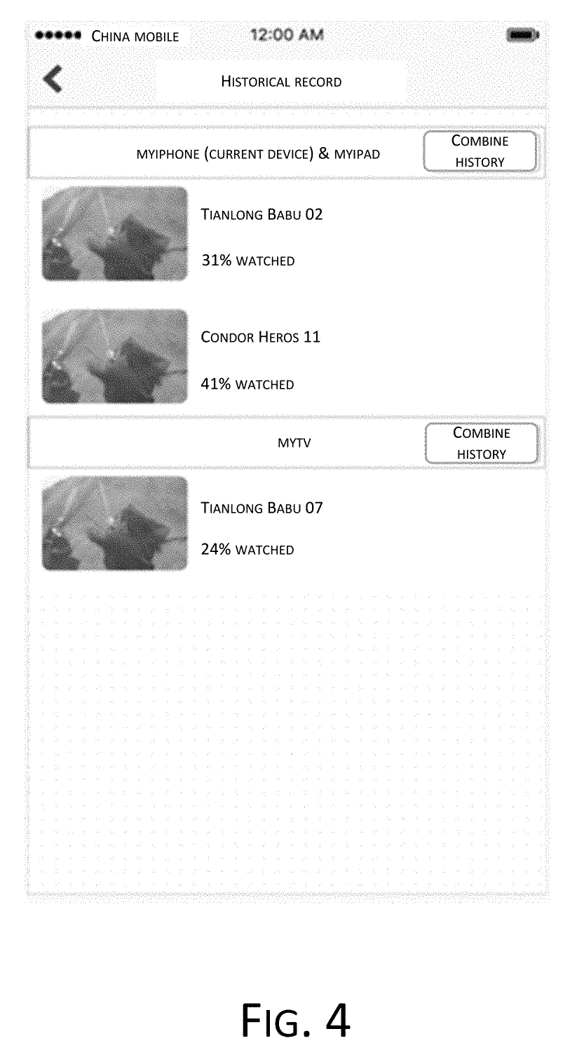

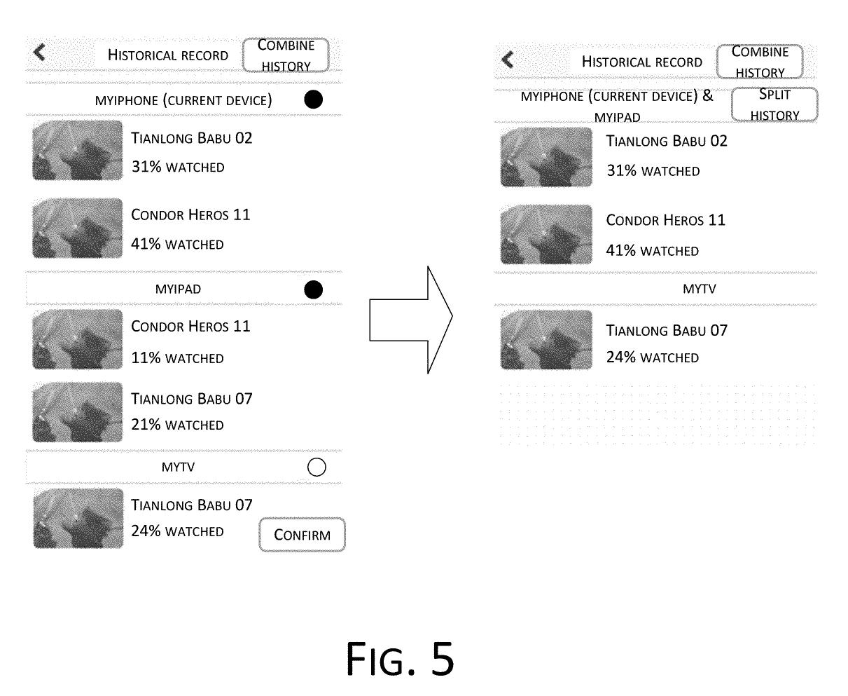

In implementations, the user sometimes does not want to divide playing progresses of various terminal devices at great length, but wants to treat two or more terminal devices as a same terminal device. Progresses about playing a video in these terminal devices can be overwritten mutually. For example, a user has two terminal devices, one is a mobile phone, and the other is a tablet computer. The user may use different terminal devices at different time periods. When the user watches a same drama series using these two terminal devices, it is not desirable to distinguish between playing progresses of these two terminal devices because the same user is watching. In this case, the user can issue a combination command that combines playing progresses of at least two terminal devices in a historical record page. Specifically, a button for combination progresses may be set in the historical record page, and the button may be labeled with an indicative term of “combine progresses” or “history of combination”. When the button is triggered by the user, a combination of playing progresses of a plurality of terminal devices can be implemented. In practical applications, implementations of combination progresses can also take a number of forms. As shown in FIG. 3, a progress combination button may be set in playing sub-records of terminal devices other than the current device. When a progress combination button of a certain terminal device is clicked, a playing sub-record of that terminal device can be automatically combined with the playing sub-record of the current device, thereby obtaining a combined playing sub-record, as shown in FIG. 4. In addition, referring to FIG. 5, a unified progress combination button can also be set in a historical record. When the button is triggered, a playing sub-record of each terminal device in the historical record page can be converted into an editable state. As shown in FIG. 5, a playing sub-record in an editable state can have a selection control, and the user can select multiple playing sub-records that need to be combined by triggering selection controls. After selection, the user can combine the selected playing sub-records by clicking a confirmation button.

In implementations, the user issues a progress combination command in the terminal device regardless of which way a progress combination function is implemented. After the progress combination command is received by the terminal device, the terminal device may parse at least two terminal devices for which the progress combination command is directed. For example, in FIG. 3, after the user triggers a history combination button in myipad, the current device can know that playing sub-records of myipad and myiphone need to be combined. For another example, in FIG. 5, after the user selects myipad and mytv, the current device can know that playing sub-records of myipad and mytv need to be combined.

In implementations, after the terminal device that receives the progress combination command parses the at least two terminal devices that need to be combined, the terminal device may send a progress combination request to the server. The progress combination request may include identifiers of the at least two terminal devices that are to be combined. After receiving the progress combination request, the server may extract the identifiers of the at least two terminal devices, and may combine playing sub-records of the at least two terminal devices in the video playing record of the specified account. In practical applications, a playing progress of each video in a video playing record can be associated with a progress backup time. The progress backup time may be the time when the server stores a playing progress of an associated video. For example, the server stores a playing progress of watching 31% of the second episode of “Tianlong Babu” into a playing sub-record of a mobile phone terminal under the specified user account at 20:08:56 on Jun. 14, 2017. In this case, such time of 20:08:56 on Jun. 14, 2017 can be used as a progress backup time for the playing progress of watching 31% of the second episode of “Tianlong Babu” in the playing sub-record of the mobile phone terminal. In implementations, when playing sub-records of the at least two terminal devices are combined, the server may sequentially combine a playing progress of each video in the playing sub-records. Specifically, the server may determine at least one playing progress of a current video in the playing sub-records of the at least two terminal devices, and use a playing progress having the latest progress backup time in the at least one playing progress as a combined playing progress of the current video. The at least one playing progress may generally include all playing progresses of the current video that appear in a plurality of playing sub-records that need to be combined. For example, the current video is a drama series of “Tianlong Babu”, and a plurality of playing sub-records that need to be combined include a time A when conducting a backup about a progress indicating 31% of the second episode has been watched and a time B when conducting a backup about a progress indicating 35% of the seventh episode has been watched. If the time A is later than the time B, the progress of 31% of the second episode is used as a combined playing progress of the drama series of “Tianlong Babu”. In this way, after the combined playing progress of the current video is obtained, the combined playing progress of the current video may be written into a combined playing sub-record. For example, in FIG. 4, in combined playing sub-records, respective playing progresses of a drama series of “Condor Heroes” and a drama series of “Tianlong Babu” are combined, and previous four playing progresses are combined into two playing progresses respectively.

In implementations, after the playing sub-records of the at least two terminal devices are combined, the at least two terminal devices may be regarded as the same terminal device. In this way, when receiving a target progress backup request sent by any one of the at least two terminal devices, a playing progress included in the target progress backup request may be stored in the combined playing sub-record. When the playing progress included in the target progress backup request is stored in the combined playing sub-record, if a playing progress of a video indicated by the playing progress that is included in the target progress backup request already exists in the combined playing sub-record, the playing progress of the video that already exists in the combined playing sub-record may be overwritten by the playing progress included in the target progress backup request. In other words, playing progresses that are generated in the at least two terminal devices after combination can be mutually overwritten. For example, after playing sub-records of a mobile phone terminal and a television terminal are combined, only a playing progress of the video included in the latest progress backup request is retained in a combined playing sub-record if the mobile phone terminal and the television terminal successively send progress backup requests for the same video, and a previous playing progress is overwritten.

In implementations, after the server combines the progresses, the server may return the combined playing record to the terminal device. In this way, after receiving the combined playing record of the specified user account, the terminal device may display the combined playing record in the current historical record page. The combined playing record includes a combined playing sub-record. Videos displayed in the combined playing sub-record are a union of videos in the playing sub-records of the at least two terminal devices, and text information used for representing the at least two terminal devices is displayed in the combined playing sub-record. As shown in FIG. 4, after playing sub-records of myiphone and myipad are combined, a combined playing sub-record includes original drama series of “Tianlong Babu” and “Condor Heroes”. Furthermore, a term of “myiphone&myipad” is also indicated in the combined playing sub-record.

In implementations, video playing records in the server change as terminal devices are combined. Before combination, playing progresses generated in various terminal devices are independently recorded. After the combination, the playing progresses generated in the terminal devices that are included in the combination are recorded in a same playing sub-record, and playing progresses of a same video are mutually overwritten. In this case, the user may also execute a progress splitting command in the terminal device. The progress splitting command is opposite to the progress combination command, and is to split a plurality of terminal devices in a combination into independent terminal devices. As shown in FIG. 4, in a combined playing sub-record, a split control indicating a term “split history” or “split progress” may be set. When the split control is triggered by the user, multiple terminal devices in a combination are split back into independent terminal devices, and the terminal devices after splitting have their own playing sub-records without mutual interference.

In implementations, after the user triggers the progress splitting command in the terminal device, the terminal device can parse at least two terminal devices that need to be split. In this way, the terminal device may send a progress splitting request to the server. The request may include identifiers of the at least two terminal devices, indicating that a current combined playing sub-record needs to be split into individual playing sub-records of the at least two terminal devices. After receiving the progress splitting request, the server may split the combined playing sub-record into multiple playing sub-records. Each playing sub-record may correspond to a respective terminal device. In implementations, since a video playing record in the server is also changed at the time when playing sub-records are combined, a same playing progress can be displayed in each of the playing sub-records after splitting. Specifically, when the combined playing sub-record is split, a playing progress of a video in the combined playing sub-record may be used as an initial playing progress of the video in the playing sub-records obtained after the splitting. In this way, initial playing progresses of the video are completely consistent in each playing sub-record that are obtained after the splitting, and subsequent progress updates may be performed for different terminal devices according to the manner described at step S102. For example, a combined playing sub-record shows that 31% of the second episode of “Tianlong Babu” has been watched and 41% of the eleventh episode of “Condor Heroes” has been watched. The combined playing sub-record is shared by myiphone and myipad. Then, after splitting, playing sub-records of myiphone and myipad are respectively obtained. However, these two playing sub-records both show that 31% of the second episode of “Tianlong Babu” has been watched and 41% of the eleventh episode of “Condor Heroes” has been watched.

In implementations, after receiving the progress combination request sent by the terminal device, the server may not change the video playing record of the specified user account, but rather create a combined playing record of the specified user account. Initial content in the newly created combined playing record is a copy of the video playing record of the specified user account. Playing sub-records of the at least two terminal devices may then be combined in the combined playing record according to the technical solutions in the foregoing embodiments. In other words, in implementations, two playing records exist under the specified user account after the progresses are combined. One is a video playing record in which a playing sub-record of each terminal device is still separately updated. The other is a combined playing record of which the terminal devices in the combination are regarded as the same terminal device. In this way, in response to receiving a target progress backup request sent by a target terminal device in the at least two terminal devices, a playing progress included in the target progress backup request needs to be stored into the combined playing sub-record on the one hand. On the other hand, the playing progress included in the target progress backup request also needs to be stored into a playing sub-record of the target terminal device in the video playing record. In other words, each terminal device also maintains its own playing sub-record in the video playing record, and does not interfere with each other. However, play progresses of the terminal devices in the combination are mutually overwritten in the combined playing record. In this way, when receiving a playing record loading request directed to the specified user account, the server may only return the combined playing record of the specified user account to a requesting party that sends the playing record loading request, without returning video playback records of each terminal device that are independently kept. In this way, a client can display the combined playing sub-record normally.

In implementations, each terminal device maintains an independent video playing record that can be used when the server receives a progress splitting request. When the server receives a progress splitting request, the combined playing record may be deleted in response to the progress splitting request, and each terminal device keeps the independent video playing record. In this way, when receiving a playing record loading request directed to the specified user account at a later time, the video playing record of the specified user account may be directly returned to a requesting party that sends the playing record loading request. In other words, according to this mode of processing, after the user splits the terminal devices in the combination, since what are loaded are video playback records that are independently maintained by the terminal devices, initial video playing progresses displayed in multiple playing sub-records that are obtained can be not exactly the same, but are displayed according to actual playing progresses. In this way, even if a plurality of terminal devices are combined and then split, playing progresses of the plurality of terminal devices do not interfere with each other.

As can be seen from the above, according to different combination methods, after splitting, content of each split playing sub-record displayed in the terminal device may also be different. A playing progress of a video displayed in the split playing record may be a playing progress of the video in the combined playing sub-record when the combined playing sub-record is split. Alternatively, a playing progress of a video displayed in the playing record that is obtained after splitting may be a playing progress of the video played in a corresponding terminal device.

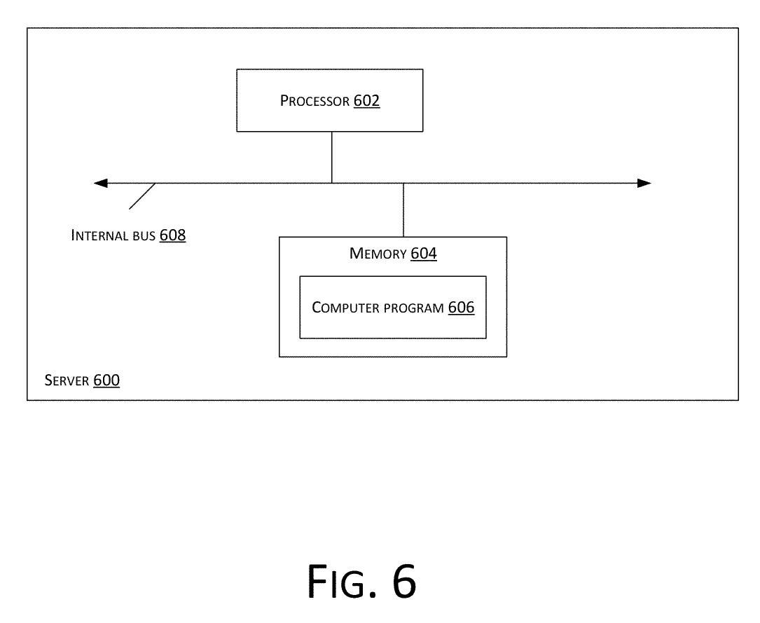

Referring to FIG. 6, the present application further provides a server 600. The server 600 includes a processor 602 and memory 604. The memory 604 stores a computer program 606. In implementations, the server 600 may further include an internal bus 608. When the computer program 606 is executed by the processor 602, the following operations are implemented.

S102: Receive a progress backup request sent by a current terminal device, the progress backup request including a playing progress of a target video on the current terminal device, and an identifier used for representing the current terminal device; where the current terminal device is logged in with a specified user account.

S104: Determine a playing sub-record of the current terminal device from a video playing record of the specified user account based on the identifier.

S106: Store the playing progress of the target video on the current terminal device in the playing sub-record of the current terminal device to update the video playing record of the specified user account.

In implementations, the memory 604 may include a physical device used for storing information, typically by digitizing the information and then storing thereof in a media that utilizes electrical, magnetic or optical means. The memory 604 as described in implementations may further include a device that stores information through an electrical energy means, such as RAM, ROM, etc., a device that stores information through a magnetic energy means, such as a hard disk, a floppy disk, a magnetic tape, a magnetic core memory, a magnetic bubble memory, and a USB flash drive, A device that stores information through an optical means, such as a CD or a DVD. Apparently, storage devices of other means also exist, such as quantum memory, graphene memory, etc.

In implementations, the memory 604 may include a form of computer readable media such as a volatile memory, a random access memory (RAM) and/or a non-volatile memory, for example, a read-only memory (ROM) or a flash RAM. The memory 604 is an example of a computer readable media.

The computer readable media may include a volatile or non-volatile type, a removable or non-removable media, which may achieve storage of information using any method or technology. The information may include a computer-readable instruction, a data structure, a program module or other data. Examples of computer storage media include, but not limited to, phase-change memory (PRAM), static random access memory (SRAM), dynamic random access memory (DRAM), other types of random-access memory (RAM), read-only memory (ROM), electronically erasable programmable read-only memory (EEPROM), quick flash memory or other internal storage technology, compact disk read-only memory (CD-ROM), digital versatile disc (DVD) or other optical storage, magnetic cassette tape, magnetic disk storage or other magnetic storage devices, or any other non-transmission media, which may be used to store information that may be accessed by a computing device. As defined herein, the computer readable media does not include transitory media, such as modulated data signals and carrier waves.

In implementations, the processor 602 can be implemented in any suitable manner. For example, the processor can take a form of a microprocessor or a processor, for example, and a form of computer readable media, logic gates, switches, application specific integrated circuit (ASIC), programmable logic controllers, and embedded microcontrollers, etc., which stores computer readable program codes (e.g., software or firmware) executable by the (micro) processor.

Specific functions of the processor 602 and the memory 604 of the server 600 provided by the embodiments of the present specification can be explained with reference to the foregoing embodiments in the present specification, and the technical effects of the foregoing embodiments can be achieved thereby. Details thereof are not repeatedly described herein.

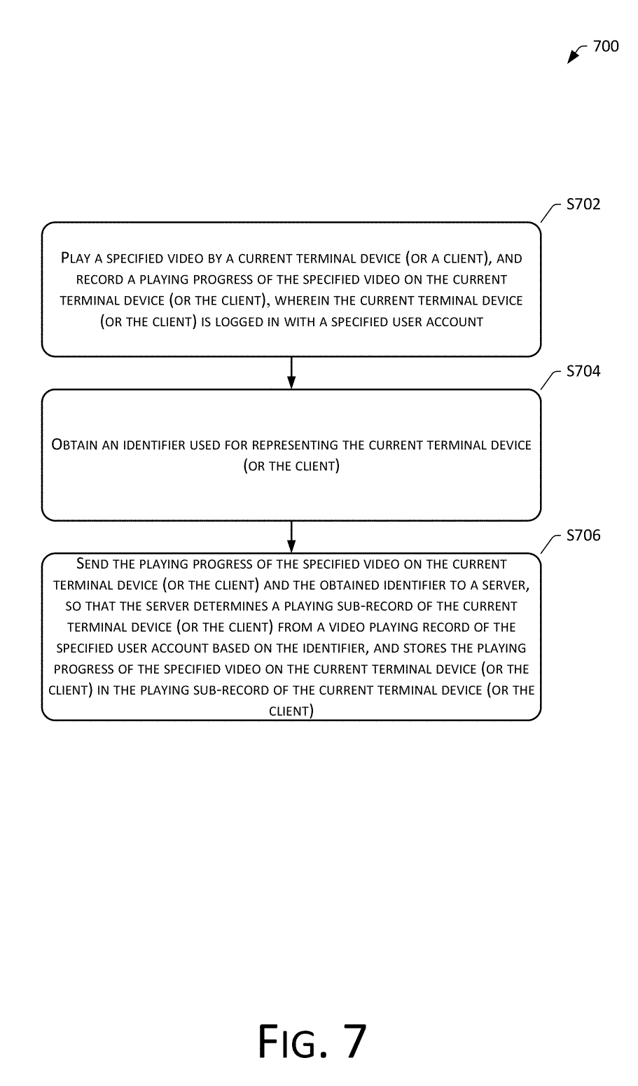

The present application also provides a method for updating a playing record. The method can be applied in a client. The client may be a terminal device used by a user, or may be software running in the terminal device. Referring to FIG. 7, a method 700 includes the following operations.

S702: Play a specified video by a current terminal device, and record a playing progress of the specified video on the current terminal device, wherein the current terminal device is logged in with a specified user account.

In implementations, when a user accesses a video playing website through a current terminal device, a specified user account that has been registered in the video playing website may be logged in the current terminal device. Information of the user may be stored in association with the specified user account in a server of the video playing website. The information of the user may include information inputted by the user at the time of registration, such as nickname, gender, date of birth, hobbies, etc. and may also include behavior data of the user when browsing the video playing website, for example, themes that the user likes to watch, online time durations of the user, a video playing record of the user, and so on.

In implementations, when the specified user account remains in a login state, if the user is watching a certain video, the current terminal device can send the playing progress of the video that the user is watching to the server, thereby backing up the video playing record of the user through the server. Specifically, when the current terminal device plays the target video, a playback page of the target video or the APP of the video play website records a current playing progress of the target video according to a specified period. The specified period may be pre-specified by a developer of the video playing website. For example, the specified period may be 2 seconds. In this way, the current playing progress of the target video can be recorded every 2 seconds. The current playing progress may be a current playing time duration of the target video. For example, when the current playing progress is recorded, the target video is played to 4 minutes and 15 seconds. Then, 4 minutes and 15 seconds can be used as the current playing progress. In addition, the current playing progress may also be a proportion of the current playing time duration of the target video in the total time duration. For example, when the current playing progress is recorded, the target video is played for 4 minutes and 15 seconds, and the total time duration of the target video is 10 minutes. Then, a ratio between 4 minutes 15 seconds and 10 minutes, 42.5%, can be used as the current playing progress. Apparently, in practical applications, the APP of the video playing website can also record the current playing progress of the target video when the APP is closed or exited from a current interface. Specifically, in response to receiving an instruction of closing or exiting, the APP may record the current playing progress of the target video that is played in the APP, and then may send the current playing progress that is recorded and an identifier of the target video to the server, so that the server can back up the current playing progress of the target video.

S704: Obtain an identifier used for representing the current terminal device.

In implementations, while the playing progress of the target video in the current terminal device is recorded, an identifier used for representing the current terminal device may be obtained in order to clearly indicating that the playing progress is recorded in the current terminal device. Specifically, the identifier may be used to uniquely represent the current terminal device, so that the current terminal device can be distinguished from other terminal devices. In practical applications, the identifier may be a unique character string such as an International Mobile Equipment Identity (IMEI) or a MAC address of the current terminal device. In addition, the identifier may be a character string obtained after performing a hash mapping on the above IMEI or MAC address. For example, the identifier may be an MD5 code generated from the IMEI. In implementations, the identifier may be stored in a specified directory of the current terminal device when the current terminal device is produced or activated. In this way, by reading data in the specified directory, the identifier used for representing the current terminal device can be obtained.

S706: Send the playing progress of the specified video on the current terminal device and the obtained identifier to a server, so that the server determines a playing sub-record of the current terminal device from a video playing record of the specified user account based on the identifier, and stores the playing progress of the specified video on the current terminal device in the playing sub-record of the current terminal device.

In implementations, after the playing progress of the target video is recorded and the identifier of the current terminal device is obtained, the current terminal device may initiate a progress backup request to the server. The request may include the recorded playback progress and the obtained identifier. Apparently, in practical applications, the progress backup request may further include an identifier that is used for representing the specified user account. The identifier that represents the specified user account may be the specified user account itself, or may be a background digital series number corresponding to the specified user account. The present application does not have any limitations on implementations thereof, as long as the uniqueness can be guaranteed.

In implementations, the server may update a playing progress generated by a target video on the current terminal device according to the technical solutions described in steps S104 and S106 in the foregoing embodiments.

In implementations, the video playing website may have a historical record page of a user. The historical record page can display a video playing record of the user. Specifically, the user can log into the specified user account on a terminal device. As such, if a current page of the terminal device jumps to a historical record page, the terminal device can automatically send a request for loading a playing record that is directed to the specified user account to the server. The request for loading a playing record may include an identifier that represents the specified user account. The identifier may be the specified user account itself, or may be a corresponding digital series number of the specified user account in the video playing website. In this way, after receiving the request for loading a playing record, the server may return the video playing record of the specified user account to a requester that sends the request for loading the playing record.

In implementations, after receiving the video playing record returned by the server, the terminal device may display the video playing record in the current historical record page. Referring to FIG. 3, the video playing record may include playing sub-records of a plurality of terminal devices, and names of the terminal devices and playing progresses of various videos respectively generated in the terminal devices may be displayed. In implementations, since an identifier of a terminal device described above is unique, a representation thereof is usually complicated and difficult to be remembered by the user. Therefore, in order to facilitate identification by the user, a name that is easily recognized by the user as described in the foregoing embodiments can be employed when being presented to the user.

In implementations, in order to distinguish the terminal device currently used by the user from other terminal devices, the playing sub-record of the current terminal device may be displayed before the playing sub-records of the other terminal device. For example, in FIG. 3, the user currently uses a mobile phone. A playing sub-record of the mobile phone can then be displayed in the first place, and a term “current device” can be indicated after a name of the mobile phone is indicated.

In implementations, playing sub-records of at least two terminal devices may be combined or split by using the technical solutions described in the foregoing embodiments. According to different combination methods, after final splitting, content of each split playing record displayed in a terminal device may also be different. A playing progress of a video displayed in the split playing record may be a playing progress of the video in a combined playing sub-record when the combined playing sub-record is split. Alternatively, the playing progress of the video displayed in the playing sub-record obtained from the splitting may be a playing progress of the video played in a corresponding terminal device.

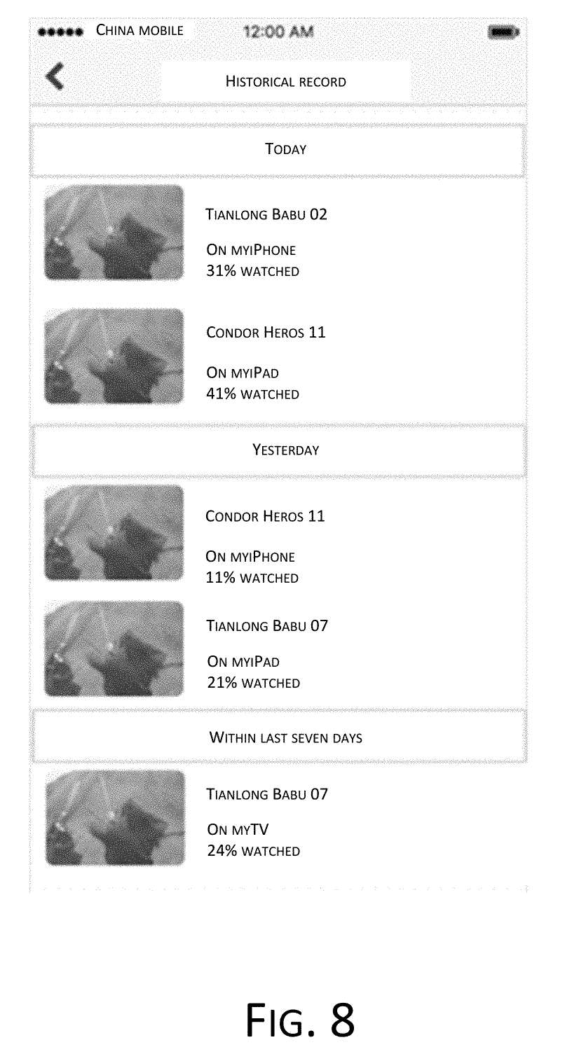

In implementations, a playing progress of a video in the video playing record under the specified user account may be associated with a progress backup time. In this way, in a historical record page of the terminal device, a respective playing progress of each video can also be displayed according to time periods. Specifically, playing progresses of videos in the video playing record may be classified and displayed according to time periods to which respective backup times belong. A playing progress of a video that is classified and displayed is labeled with a terminal device corresponding to the playing progress of the video. Referring to FIG. 8, playing progresses of videos displayed in a historical record may be displayed according to dates. Among playing progresses displayed under “Today”, a progress backup time corresponding to a playing progress of each video may fall in a “Today” time period. In this way, by dividing time periods according to progress backup times, playing progresses of videos in different playing sub-records can be displayed under a same time period classification. In order to distinguish different terminal devices, a name of a terminal device corresponding to a playing progress of each video may be marked in the playing progress of the respective video as shown in FIG. 8.

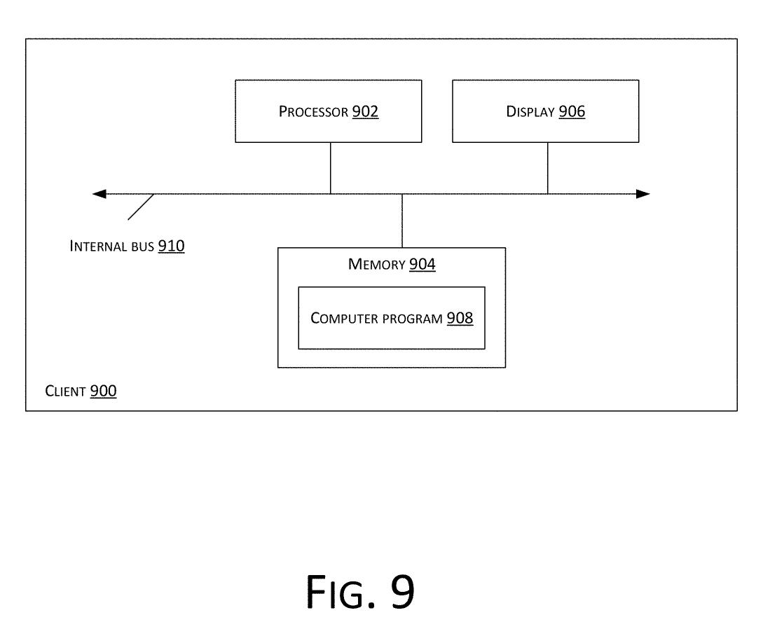

Referring to FIG. 9, the present application further provides a client 900, which includes a processor 902, memory 904, and a display 906. The memory 904 stores a computer program 908. In implementations, the client 900 may further include an internal bus 910. When the computer program 908 is executed by the processor 902, the following operations are implemented.

S702: Play a specified video through the display, and record a playing progress of the specified video on the client, wherein the client is logged in with a specified user account.

S704: Obtain an identifier used for representing the client.

S706: Send the playing progress of the specified video on the client and the obtained identifier to a server, so that the server determines a playing sub-record of the client from a video playing record of the specified user account based on the identifier, and stores the playing progress of the specified video on the client in the playing sub-record of the client.

In implementations, the memory 904 may include a physical device used for storing information, typically by digitizing the information and then storing thereof in a media that utilizes electrical, magnetic or optical means. The memory 904 as described in implementations may further include a device that stores information through an electrical energy means, such as RAM, ROM, etc., a device that stores information through a magnetic energy means, such as a hard disk, a floppy disk, a magnetic tape, a magnetic core memory, a magnetic bubble memory, and a USB flash drive, A device that stores information through an optical means, such as a CD or a DVD. Apparently, storage devices of other means also exist, such as quantum memory, graphene memory, etc.

In implementations, the memory 904 may include a form of computer readable media such as a volatile memory, a random access memory (RAM) and/or a non-volatile memory, for example, a read-only memory (ROM) or a flash RAM. The memory 904 is an example of a computer readable media as described in the foregoing description.

In implementations, the processor 902 can be implemented in any suitable manner. For example, the processor can take a form of a microprocessor or a processor, for example, and a form of computer readable media, logic gates, switches, application specific integrated circuit (ASIC), programmable logic controllers, and embedded microcontrollers, etc., which stores computer readable program codes (e.g., software or firmware) executable by the (micro) processor.

In implementations, the display 906 may be a display tool that displays a certain electronic file onto a screen through a specific transmission device and then reflects thereof to the human eye. The display may include a liquid crystal LCD display, a cathode ray tube CRT display, a light emitting diode LED display, etc.

Specific functions that are implemented, the memory, the processor and the display of the client provided by the embodiments of the present specification can be explained with reference to the foregoing embodiments in the present specification, and the technical effects of the foregoing embodiments can be achieved thereby. Details thereof are not repeatedly described herein.

As can be seen from the above, in the technical solutions provided by the present application, when a user logs in with a specified user account in a current terminal device and uses the current terminal device to watch a video, the current terminal device can send the playing progress of the video and an identifier thereof to a server. In this way, when updating a video playing record of the user, the server can determine which terminal device the playing progress is generated from by using the received identifier. The video playing record of the specified user account may be saved in the server, and the video playing record may be divided into multiple playing sub-records according to different terminal devices. When updating the playing progress of the video, the server may save the playing progress of the video into a playing sub-record of the current terminal device, indicating that the playing progress of the video is generated in the current terminal device. For playing sub-records of other terminal devices, no changes may be made. Thus, when terminal devices that are logged in with the specified user account need to load a video playing record, the server can provide a video playing record including various playing sub-records. When the terminal devices display the video playing record, the video playing record can be classified and displayed according to the terminal devices. In this way, even if two users watch the same episode using the same account, as long as these two users use their individual terminal devices, their viewing records will not be overwritten by each other, and will be recorded separately in playing sub-records of their individual terminal devices. By distinguishing between terminal devices in a video playing record, a user can accurately know the progress of watching a video thereof without being confused with viewing progresses of others. As can be seen, the technical solutions provided by the present application can distinguish between playing records of different users.

In the 1990s, a technical improvement may be clearly differentiated by hardware improvements (for example, improvements in circuit structures such as diodes, transistors, switches, etc.) or software improvements (improvements in methods and processes). However, with the development of technologies, a number of today's method and process improvements can be seen as direct improvements in hardware circuit architectures. Designers can mostly incorporate improved methods and processes into hardware circuits to obtain corresponding hardware circuit structures. Accordingly, it cannot be said that an improvement in a method and process cannot be achieved using hardware entity modules. For example, a programmable logic device (Programmable Logic Device, PLD) (e.g., Field Programmable Gate Array, FPGA) is one such integrated circuit logic function performed and determined by a user to program the device. With a designer to program a digital system for “integrating” into a PLD on his/her own, it is not necessary to have a chip manufacturer to design and manufacture a dedicated integrated circuit chip. Further, by replacing manually produced integrated circuit chips, this type of programming is also mostly replaced by “logic compiler” software. Similar to a software compiler, such logic compiler compiles original codes written by a specific programming language, which is called a hardware description language (Hardware Description Language, HDL). HDL is not the only one, and there are many kinds, such as ABEL (Advanced Boolean Expression Language), AHDL (Altera Hardware Description Language), Confluence, CUPL (Cornell University Programming Language), HDCal, JHDL (Java Hardware Description Language), Lava, Lola, MyHDL, PALASM, RHDL (Ruby Hardware Description Language), etc. The most common ones are VHDL (Very-High-Speed Integrated Circuit Hardware Description Language) and Verilog2. One skilled in the art should understand that a logic method flow may be achieved in hardware circuits by performing a little logic programming and compiling these methods into an integrated circuit using hardware description language. It should also be apparent to one skilled in the art that hardware circuits implementing the logic methods and processes can easily be obtained with logic programming using a few hardware description languages simply by programming the methods and processes into integrated circuits.

One skilled in the art also knows that, besides implementing the clients and the servers in a manner of purely computer-readable program codes, method steps can be logically programmed entirely to allow the clients and the servers to implement the same functions in a form of logic gates, switches, application-specific integrated circuits, programmable logic controllers, and embedded microcontrollers. Therefore, these types of the clients and the servers may be considered as a hardware component, and apparatuses included therein for realizing various functions may also be regarded as structures within the hardware component. Alternatively, even an apparatus for realizing various functions may be regarded as a software module that implements the method, and may also be a structure within a hardware component.

It will be apparent to one skilled in the art from the above description of the embodiments that the present application can be implemented by means of software plus a necessary hardware platform. Based on such understanding, the essence of technical solutions of the present application or the parts that make contributions to the existing technologies may be manifested in a form of a software product. The computer software product may be stored in a storage media, such as ROM/RAM, a magnetic disk, an optical disk, etc., and includes a plurality of instructions for causing a computing device (which may be a personal computer, a server, or a network device, etc.) to execute the method described in each embodiment or a portion of each embodiment.

Various embodiments in the present specification are described in a progressive manner. Same or similar parts between the various embodiments may be referred to each other. Each embodiment puts emphasis on aspects that are different from those of other embodiments. In particular, for the embodiments of the clients and the servers, reference can be made to the introduction of the embodiments of the foregoing methods.

The present application can be described in the general context of computer-executable instructions executed by a computer, such as a program module. Generally, program modules include routines, programs, objects, components, data structures, etc., that perform particular tasks or implement particular abstract data types. The present application can also be practiced in distributed computing environments. In these distributed computing environments, tasks are performed by remote processing devices that are connected through a communication network. In a distributed computing environment, program module(s) can be located in both local and remote computer storage media including storage devices.

Although the present application has been described using the embodiments, one of ordinary skill in the art understands that a number of variations and modifications exist in the present application without departing the spirit of the present application.

The present disclosure can be further understood using the following clauses.

Clause 1: A server comprising: a processor and memory, the memory storing a computer program, wherein the computer program, when executed by the processor, implements the following steps: receiving a progress backup request sent by a current terminal device, wherein the progress backup request includes a playing progress of a target video on the current terminal device and an identifier that represents the current terminal device, and the current terminal device is logged in with a specified user account; determining a playing sub-record of the current terminal device from a video playing record of the specified user account based on the identifier; and storing a playing progress of the target video on the current terminal device in the playing sub-record of the current terminal device to update the video playing record of the specified user account.

Clause 2: The server of Clause 1, wherein the computer program, when executed by the processor, further implements the following steps: creating the playing sub-record of the current terminal device in the video playing record of the specified user account If the playing sub-record of the current terminal device does not in the video playing record of the specified user account; and writing the playing progress of the target video on the current terminal device into the created playing sub-record correspondingly.

Clause 3: The server of Clause 1, wherein the computer program, when executed by the processor, further implements the following steps: determining whether a playing progress of the target video exists in the playing sub-record of the current terminal device; if affirmative, overwriting the playing progress of the target video that exists in the playing sub-record with the playing progress of the target video in the progress backup request; and if not, writing the playing progress of the target video in the progress backup request into the playing sub-record.

Clause 4: The server of Clause 1, wherein the computer program, when executed by the processor, further implements the following steps: receiving a progress combination request sent by the current terminal device, wherein the progress combination request includes identifiers of at least two terminal devices; and combining playing sub-records of the at least two terminal devices in the video playing record of the specified account, and storing a playing progress included in a target progress backup request in a combined playing sub-record when receiving the target progress backup request sent by any one of the at least two terminal devices.

Clause 5: The server of Clause 4, wherein playing progresses of videos in the playing sub-records of the at least two terminal devices are associated with progress backup times, and correspondingly, the computer program, when executed by the processor, further implements the following steps: determining at least one playing progress of a current video in the playing sub-records of the at least two terminal devices, and using a playing progress having a latest progress backup time in the at least one playing progress as a combined playing progress of the current video; and writing the combined playing progress of the current video into the combined playing sub-record.

Clause 6: The server of Clause 4, wherein the computer program, when executed by the processor, further implements the following step: if the video pointed by the playing progress that is included in the target progress backup request has a playing progress that exists in the combined playing record, overwriting the playing progress that exists in the combined playing sub-record by the playing progress that is included in the target progress backup request.

Clause 7: The server of Clause 4, wherein the computer program, when executed by the processor, further implements the following steps: receiving a progress splitting request sent by the current terminal device, wherein the progress splitting request is directed to the at least two terminal devices of which progresses are combined; and splitting the combined playing sub-record into a plurality of playing sub-records, and taking playing progresses of videos in the combined playing sub-record as respective initial playing progresses of the videos in the plurality of playing sub-records when the combined playing sub-record is split.

Clause 8: The server of Clause 1, wherein the computer program, when executed by the processor, further implements the following steps: receiving a progress combination request sent by the current terminal device, wherein the progress combination request includes identifiers of at least two terminal devices; creating a combined playing record of the specified user account in response to the progress combination request; and combining playing sub-records of the at least two terminal devices in the combined playing record, and storing a playing progress included in a target progress backup request into the combined playing record in response to receiving the target progress backup request sent by the target terminal device in the at least two terminal devices.

Clause 9: The server of Clause 8, wherein the computer program, when executed by the processor, further implements the following step: storing the playing progress included in the target progress backup request into a playing sub-record of the target terminal device in the video playing record in response to receiving the target progress backup request sent by the target terminal device in the at least two terminal devices.

Clause 10: The server of Clause 8 or 9, wherein the computer program, when executed by the processor, further implements the following step: returning the combined playing record of the specified user account to a requesting party that sends a playing record loading request in response to receiving the playing record loading request directed to the specified user account.

Clause 11: The server of Clause 9, wherein the computer program, when executed by the processor, further implements the following steps: receiving a progress splitting request sent by the current terminal device, wherein the progress splitting request is directed to the at least two terminal devices of which progresses are combined; deleting the combined playing record in response to the progress splitting request, and returning the video playing record of the specified user account to a requesting party that sends a playing record loading request in response to receiving the playing record loading request directed to the specified user account.

Clause 12: A client, the client comprising a processor, memory, and a display, the memory storing a computer program, wherein the computer program, when executed by the processor, further implements the following steps: playing a specified video through a current terminal device, and recording a playback progress of the specified video in the current terminal device, wherein the current terminal device is logged in with a specified user account; obtaining an identifier that represents the current terminal device; and sending the playing progress of the specified video in the current terminal device and the obtained identifier to the server, to enable the server to determine a playing sub-record of the current terminal device from a video playing record of the specified user account based on the identifier, and store the playing progress of the specified video in the current terminal device in the playing sub-record of the current terminal device.

Clause 13: The client of Clause 12, wherein the computer program, when executed by the processor, further implements the following steps: recording a current playing progress of the specified video according to a specified period when the specified video is played; and correspondingly sending the current playing progress and the obtained identifier to the server after the current playing progress of the specified video is recorded.

Clause 14: The client of Clause 12, wherein the computer program, when executed by the processor, further implements the following steps: sending a playing record loading request directed to the specified user account to the server; and receiving the video playing record of the specified user account returned by the server, and displaying the video playing record in a current page, wherein playing sub-records of a plurality of terminal devices are separately displayed in the video playing record if the specified user account has the playing sub-records of the plurality of terminal devices.

Clause 15: The client of Clause 14, wherein the computer program, when executed by the processor, further implements the following steps: continuously playing a target video in the current terminal device according to a playing progress of the target video in response to the playing progress of the target video in the video playing record being triggered; and recording the playing progress of the target video on the current terminal device when the target video is played, and transmitting the playing progress of the target video on the current terminal device and the identifier of the current terminal device to the server, so that the server stores the playing progress of the target video on the current terminal device in the playing sub-record of the current terminal device.

Clause 16: The client of Clause 14, wherein the computer program, when executed by the processor, further implements the following step: displaying the playing sub-record of the current terminal device before playing sub-records of other terminal devices when the video playing record is displayed.

Clause 17: The client of Clause 14, wherein the computer program, when executed by the processor, further implements the following steps: sending a progress combination request to the server after a progress combination command inputted by a user is received, wherein the progress combination request includes identifiers of at least two terminal devices to be combined; and receiving a combined playing record of the specified user account returned by the server, and displaying the combined playing record in a current page, wherein the combined playing record includes a combined playing sub-record, and videos displayed in the combined playing record are is a union of videos in playing sub-records of the at least two terminal devices.

Clause 18: The client of Clause 17, wherein playing progresses of the videos in the playing sub-records of the at least two terminal devices are associated with progress backup times, and correspondingly, the computer program, when executed by the processor, further implements the following steps: determining at least one playing progress of a current video in the playing sub-records of the at least two terminal devices, and using a playing progress having a latest progress backup time in the at least one playing progress as a combined playing progress of the current video; and writing the combined playing progress of the current video into the combined playing sub-record.

Clause 19: The client of Clause 17, wherein the computer program, when executed by the processor, further implements the following steps: sending a progress splitting request directed to the at least two terminal devices to the server after receiving a progress splitting command for the combined playing sub-record inputted by the user; and receiving a split playing record returned by the server, and displaying the split playing record in the current page, the split playing record including individual playing sub-records of the at least two terminal devices obtained after splitting the combined playing sub-record, wherein: playing progresses of videos displayed in the individual playing sub-records obtained after the splitting are playing progresses of the videos in the combined playing sub-record when the combined playing sub-record is split, or playing progresses of videos displayed in the individual playing sub-records obtained after the splitting are playing progresses of the videos played in a corresponding terminal device.

Clause 20: The client of Clause 14, wherein playing progresses of videos in the playing sub-records are associated with progress backup times, and correspondingly, the computer program, when executed by the processor, further implements the following step: classifying and displaying the playing progresses of the videos in the video playing record according to respective time periods to which the progress backup times, wherein the playing progresses of the videos that are classified and displayed are labeled with respective terminal devices corresponding to the playing progresses of the videos.

Clause 21: The client of Clause 14, wherein playing progresses of videos in the playing sub-records are associated with terminal devices that generate the playing progresses, and correspondingly, the computer program, when executed by the processor, further implements the following step: classifying and displaying the playing progresses of the videos in the video playing record according to the terminal devices that generate the playing progresses, wherein playing progresses displayed in a same class are associated with a same terminal device.

Clause 22: A method for updating a playing record, the method comprising: receiving a progress backup request sent by a current terminal device, wherein the progress backup request includes a playing progress of a target video on the current terminal device and an identifier that represents the current terminal device, and the current terminal device is logged in with a specified user account; determining a playing sub-record of the current terminal device from a video playing record of the specified user account based on the identifier; and storing a playing progress of the target video on the current terminal device in the playing sub-record of the current terminal device to update the video playing record of the specified user account.

Clause 23: The method of Clause 22, further comprising: receiving a progress combination request sent by the current terminal device, wherein the progress combination request includes identifiers of at least two terminal devices; and combining playing sub-records of the at least two terminal devices in the video playing record of the specified account, and storing a playing progress included in a target progress backup request in a combined playing sub-record when receiving the target progress backup request sent by any one of the at least two terminal devices.

Clause 24: The method of Clause 23, further comprising: receiving a progress splitting request sent by the current terminal device, wherein the progress splitting request is directed to the at least two terminal devices of which progresses are combined; and splitting the combined playing sub-record into a plurality of playing sub-records, and taking playing progresses of videos in the combined playing sub-record as respective initial playing progresses of the videos in the plurality of playing sub-records when the combined playing sub-record is split.

Clause 25: The method of Clause 22, further comprising: receiving a progress combination request sent by the current terminal device, wherein the progress combination request includes identifiers of at least two terminal devices; creating a combined playing record of the specified user account in response to the progress combination request; and combining playing sub-records of the at least two terminal devices in the combined playing record, and storing a playing progress included in a target progress backup request into the combined playing record in response to receiving the target progress backup request sent by the target terminal device in the at least two terminal devices.

Clause 26: The method of Clause 25, further comprising: storing the playing progress included in the target progress backup request into a playing sub-record of the target terminal device in the video playing record.

Clause 27: The method of Clause 26, further comprising: receiving a progress splitting request sent by the current terminal device, wherein the progress splitting request is directed to the at least two terminal devices of which progresses are combined; deleting the combined playing record in response to the progress splitting request, and returning the video playing record of the specified user account to a requesting party that sends a playing record loading request in response to receiving the playing record loading request directed to the specified user account.

Clause 28: A method for updating a playing record, the method comprising: playing a specified video through a current terminal device, and recording a playback progress of the specified video in the current terminal device, wherein the current terminal device is logged in with a specified user account; obtaining an identifier that represents the current terminal device; and sending the playing progress of the specified video in the current terminal device and the obtained identifier to the server, to enable the server to determine a playing sub-record of the current terminal device from a video playing record of the specified user account based on the identifier, and store the playing progress of the specified video in the current terminal device in the playing sub-record of the current terminal device.

Clause 29: The method of Clause 28, further comprising: sending a playing record loading request directed to the specified user account to the server; and receiving the video playing record of the specified user account returned by the server, and displaying the video playing record in a current page, wherein playing sub-records of a plurality of terminal devices are separately displayed in the video playing record if the specified user account has the playing sub-records of the plurality of terminal devices.

Clause 30: The method of Clause 29, further comprising: sending a progress combination request to the server after a progress combination command inputted by a user is received, wherein the progress combination request includes identifiers of at least two terminal devices to be combined; and receiving a combined playing record of the specified user account returned by the server, and displaying the combined playing record in a current page, wherein the combined playing record includes a combined playing sub-record, and videos displayed in the combined playing record are is a union of videos in playing sub-records of the at least two terminal devices.

Clause 31: The method of Clause 30, wherein playing progresses of the videos in the playing sub-records of the at least two terminal devices are associated with progress backup times, and correspondingly, playing progresses of the videos in the combined playing sub-record are determined by the following manner: determining at least one playing progress of a current video in the playing sub-records of the at least two terminal devices, and using a playing progress having a latest progress backup time in the at least one playing progress as a combined playing progress of the current video; and writing the combined playing progress of the current video into the combined playing sub-record.

Clause 32: The method of Clause 30, further comprising: sending a progress splitting request directed to the at least two terminal devices to the server after receiving a progress splitting command for the combined playing sub-record inputted by the user; receiving a split playing record returned by the server, and displaying the split playing record in the current page, the split playing record including individual playing sub-records of the at least two terminal devices obtained after splitting the combined playing sub-record, wherein: playing progresses of videos displayed in the individual playing sub-records obtained after the splitting are playing progresses of the videos in the combined playing sub-record when the combined playing sub-record is split, or playing progresses of videos displayed in the individual playing sub-records obtained after the splitting are playing progresses of the videos played in a corresponding terminal device.

Clause 33: A method implemented by a first computing device, the method comprising: receiving playing sub-records of one or more videos that are generated in a plurality of computing devices according to the plurality of computing devices; and displaying the playing sub-records of the one or more videos along with identifiers of the plurality of computing devices in a current record page of the first computing device.

Clause 34: The method of claim 33, further comprising providing an input box to a user for inputting a name as an identifier of one of the plurality of computing devices.

Clause 35: The method of claim 33, wherein the playing sub-records of the one or more videos include respective percentages of the one or more videos that have been watched in the plurality of computing devices.

Clause 36: The method of claim 33, further comprising: receiving a progress combination command inputted by a user, the progress combination request including identifiers of at least two computing devices to be combined; sending a progress combination request to a server in response to receiving the progress combination command; receiving a combined playing record of a specified user account returned by the server; and displaying the combined playing record in the current record page, wherein the combined playing record includes a combined playing sub-record, and videos displayed in the combined playing record is a union of videos in playing sub-records of the at least two computing devices.

What is claimed is:

1. A method comprising:
receiving a progress backup request sent by a current terminal device, wherein the progress backup request includes a playing progress of a target video on the current terminal device and an identifier that represents the current terminal device, and the current terminal device is logged in with a specified user account;
determining a playing sub-record of the current terminal device from a video playing record of the specified user account based on the identifier; and
storing a playing progress of the target video on the current terminal device in the playing sub-record of the current terminal device to update the video playing record of the specified user account.

2. The method of claim 1, further comprising:
creating the playing sub-record of the current terminal device in the video playing record of the specified user account If the playing sub-record of the current terminal device does not in the video playing record of the specified user account; and
writing the playing progress of the target video on the current terminal device into the created playing sub-record correspondingly.

3. The method of claim 1, further comprising:
determining whether a playing progress of the target video exists in the playing sub-record of the current terminal device;
if affirmative, overwriting the playing progress of the target video that exists in the playing sub-record with the playing progress of the target video in the progress backup request; and
if not, writing the playing progress of the target video in the progress backup request into the playing sub-record.

4. The method of claim 1, further comprising:
receiving a progress combination request sent by the current terminal device, wherein the progress combination request includes identifiers of at least two terminal devices; and
combining playing sub-records of the at least two terminal devices in the video playing record of the specified account, and storing a playing progress included in a target progress backup request in a combined playing sub-record when receiving the target progress backup request sent by any one of the at least two terminal devices.

5. The method of claim 4, wherein playing progresses of videos in the playing sub-records of the at least two terminal devices are associated with progress backup times, and the method further comprises:
determining at least one playing progress of a current video in the playing sub-records of the at least two terminal devices, and using a playing progress having a latest progress backup time in the at least one playing progress as a combined playing progress of the current video; and
writing the combined playing progress of the current video into the combined playing sub-record.

6. The method of claim 4, further comprising:
if the video pointed by the playing progress that is included in the target progress backup request has a playing progress that exists in the combined playing record, overwriting the playing progress that exists in the combined playing sub-record by the playing progress that is included in the target progress backup request.

7. The method of claim 4, further comprising:
receiving a progress splitting request sent by the current terminal device, wherein the progress splitting request is directed to the at least two terminal devices of which progresses are combined; and
splitting the combined playing sub-record into a plurality of playing sub-records, and taking playing progresses of videos in the combined playing sub-record as respective initial playing progresses of the videos in the plurality of playing sub-records when the combined playing sub-record is split.

8. The method of claim 1, further comprising:
receiving a progress combination request sent by the current terminal device, wherein the progress combination request includes identifiers of at least two terminal devices;
creating a combined playing record of the specified user account in response to the progress combination request; and
combining playing sub-records of the at least two terminal devices in the combined playing record, and storing a playing progress included in a target progress backup request into the combined playing record in response to receiving the target progress backup request sent by the target terminal device in the at least two terminal devices.

9. The method of claim 8, further comprising:
storing the playing progress included in the target progress backup request into a playing sub-record of the target terminal device in the video playing record in response to receiving the target progress backup request sent by the target terminal device in the at least two terminal devices.

10. The method of claim 8, further comprising:
returning the combined playing record of the specified user account to a requesting party that sends a playing record loading request in response to receiving the playing record loading request directed to the specified user account.

11. The method of claim 9, further comprising:
receiving a progress splitting request sent by the current terminal device, wherein the progress splitting request is directed to the at least two terminal devices of which progresses are combined; and
deleting the combined playing record in response to the progress splitting request, and returning the video playing record of the specified user account to a requesting party that sends a playing record loading request in response to receiving the playing record loading request directed to the specified user account.

12. One or more computer readable media storing executable instructions that, when executed by one or more processors, cause the one or more processors to perform acts comprising:
playing a specified video through a current terminal device, and recording a playback progress of the specified video in the current terminal device, wherein the current terminal device is logged in with a specified user account;
obtaining an identifier that represents the current terminal device; and
sending the playing progress of the specified video in the current terminal device and the obtained identifier to the server, to enable the server to determine a playing sub-record of the current terminal device from a video playing record of the specified user account based on the identifier, and store the playing progress of the specified video in the current terminal device in the playing sub-record of the current terminal device.

13. The one or more computer readable media of claim 12, the acts further comprising:
recording a current playing progress of the specified video according to a specified period when the specified video is played; and
correspondingly sending the current playing progress and the obtained identifier to the server after the current playing progress of the specified video is recorded.

14. The one or more computer readable media of claim 12, the acts further comprising:
sending a playing record loading request directed to the specified user account to the server; and
receiving the video playing record of the specified user account returned by the server, and displaying the video playing record in a current page, wherein playing sub-records of a plurality of terminal devices are separately displayed in the video playing record if the specified user account has the playing sub-records of the plurality of terminal devices.

15. The one or more computer readable media of claim 14, the acts further comprising:
continuously playing a target video in the current terminal device according to a playing progress of the target video in response to the playing progress of the target video in the video playing record being triggered; and
recording the playing progress of the target video on the current terminal device when the target video is played, and transmitting the playing progress of the target video on the current terminal device and the identifier of the current terminal device to the server, so that the server stores the playing progress of the target video on the current terminal device in the playing sub-record of the current terminal device.

16. The one or more computer readable media of claim 14, wherein the acts further comprising:
displaying the playing sub-record of the current terminal device before playing sub-records of other terminal devices when the video playing record is displayed.

17. The one or more computer readable media of claim 14, wherein the acts further comprising:
sending a progress combination request to the server after a progress combination command inputted by a user is received, wherein the progress combination request includes identifiers of at least two terminal devices to be combined; and
receiving a combined playing record of the specified user account returned by the server, and displaying the combined playing record in a current page, wherein the combined playing record includes a combined playing sub-record, and videos displayed in the combined playing record are is a union of videos in playing sub-records of the at least two terminal devices.

18. The one or more computer readable media of claim 17, wherein playing progresses of the videos in the playing sub-records of the at least two terminal devices are associated with progress backup times, and the acts further comprise:
determining at least one playing progress of a current video in the playing sub-records of the at least two terminal devices, and using a playing progress having a latest progress backup time in the at least one playing progress as a combined playing progress of the current video; and
writing the combined playing progress of the current video into the combined playing sub-record.

19. The one or more computer readable media of claim 17, the acts further comprising:
sending a progress splitting request directed to the at least two terminal devices to the server after receiving a progress splitting command for the combined playing sub-record inputted by the user; and
receiving a split playing record returned by the server, and displaying the split playing record in the current page, the split playing record including individual playing sub-records of the at least two terminal devices obtained after splitting the combined playing sub-record, wherein:
playing progresses of videos displayed in the individual playing sub-records obtained after the splitting are playing progresses of the videos in the combined playing sub-record when the combined playing sub-record is split, or
playing progresses of videos displayed in the individual playing sub-records obtained after the splitting are playing progresses of the videos played in a corresponding terminal device.

20. A method implemented by a first computing device, the method comprising:
receiving playing sub-records of one or more videos that are generated in a plurality of computing devices according to the plurality of computing devices; and
displaying the playing sub-records of the one or more videos along with identifiers of the plurality of computing devices in a current record page of the first computing device.

21. The method of claim 20, further comprising providing an input box to a user for inputting a name as an identifier of one of the plurality of computing devices.

22. The method of claim 20, wherein the playing sub-records of the one or more videos include respective percentages of the one or more videos that have been watched in the plurality of computing devices.

23. The method of claim 20, further comprising:
receiving a progress combination command inputted by a user, the progress combination request including identifiers of at least two computing devices to be combined;
sending a progress combination request to a server in response to receiving the progress combination command;
receiving a combined playing record of a specified user account returned by the server; and
displaying the combined playing record in the current record page, wherein the combined playing record includes a combined playing sub-record, and videos displayed in the combined playing record is a union of videos in playing sub-records of the at least two computing devices.
